(19) United States
(12) Patent Application Publication
(10) Pub. No.: US 2014/0176096 A1
(43) Pub. Date: Jun. 26, 2014

(54) SEMICONDUCTOR DEVICE AND POWER SUPPLY SYSTEM INCLUDING THE SAME

(71) Applicant: PANASONIC CORPORATION, Osaka (JP)

(72) Inventor: Hiroo YAMAMOTO, Kyoto (JP)

(73) Assignee: PANASONIC CORPORATION, Osaka (JP)

(21) Appl. No.: 14/193,955

(22) Filed: Feb. 28, 2014

Related U.S. Application Data
(63) Continuation of application No. PCT/JP2012/003912, filed on Jun. 14, 2012.

(30) Foreign Application Priority Data
Sep. 14, 2011 (JP) 2011-200392

(51) Int. Cl. H02M 3/158

(52) U.S. Cl. CPC H02M 3/158
USPC 323/271

(57) ABSTRACT

In a semiconductor device, a resistance divider includes a first resistor connecting a supply line to an output node of an analog control signal, a second resistor connecting an output node to ground, a first switching device that is turned on or off by a control circuit, and a second switching device that turns on in response to a voltage equal to the voltage of the supply line. The control circuit turns on the first switching device until a power supply voltage reaches a predetermined voltage, and then turns on or off the first switching device.

### CROSS-REFERENCE TO RELATED APPLICATIONS

This is a continuation of International Application No. PCT/JP2012/003912 filed on Jun. 14, 2012, which claims priority to Japanese Patent Application No. 2011-200392 filed on Sep. 14, 2011. The entire disclosures of these applications are incorporated by reference herein.

### BACKGROUND

The present disclosure relates to semiconductor devices, and particularly to a technique for dynamically controlling a power supply voltage.

A typical power supply system performs a feedback control of an output voltage in order to obtain a predetermined output voltage. A power supply system illustrated in FIG. 11 includes an output circuit, a feedback circuit, and a PWM modulator. The power supply system divides an output voltage Vout output from the output circuit in the feedback circuit, and feeds a voltage Vc (an error signal) from the feedback circuit back to a pulse width modulation (PWM) modulator (see, for example, FIG. 3 in Kazuhide Sakamoto, “Fourth: both the low voltage and small size, the switching regulator of ECM control,” Nikkei Electronics, Nikkei B P, May 18, no. 1004, pp. 112-117).

In the power supply system, when the output voltage Vout is higher than a predetermined voltage, an error signal Vc is low, whereas when the output voltage Vout is lower than the predetermined voltage, the error signal Vc is high. Then, the error signal Vc is input to the PWM modulator, and in response to a pulse signal having an on-time Ton in accordance with the value of the error signal Vc, the output voltage Vout is controlled to the predetermined voltage, i.e., the output voltage Vout becomes a steady state.

Another power supply system divides an output voltage Vout by using two resistors (see, for example, FIG. 1 in Bob Bell and David Pace, “Buck Regulator Topologies for Wide Input/Output Voltage Differentials”, [online]. National Semiconductor, 2006, retrieved on 2011 Aug. 29 from the Internet: <URL: http://www.national.com/assets/en/appnotes/national_power_designer111.pdf>).

In the power supply system, the input/output voltage of each circuit varies depending on, for example, variations in fabrication of the circuit. Since the feedback circuit illustrated in FIG. 11 has a fixed voltage division ratio, a variation of an input voltage to the feedback circuit causes an error signal Vc to vary. Consequently, it takes time to obtain a predetermined output voltage Vout, and thus, the power supply system has poor responsiveness in power supply control. The poor responsiveness deteriorates operating characteristics of a circuit that operates using an output voltage Vout as a power supply voltage.

### SUMMARY

A possible technique to solve the above-described problems is making the voltage division ratio of the feedback circuit illustrated in FIG. 11 variable. For example, a switching device is connected to a resistor R in parallel, and an on or off state of this switching device is controlled.

Simply controlling an on or off state of the switching device, however, has the following problems. The switching device has an ON resistance, which varies depending on a voltage applied across both ends of the switching device, i.e., an output voltage Vout. Specifically, in a rising period from when a power supply system is powered on to when the output voltage Vout reaches a predetermined voltage, for example, when the switching device turns on, a variation of the ON resistance thereof causes a transient change in an error signal Vc. Thus, the output voltage Vout, i.e., the power supply voltage, shows a distorted characteristic as shown in FIG. 12. In FIG. 12, the solid line indicates an actual characteristic of a power supply voltage and the broken line indicates an expected characteristic of the power supply voltage. In some design of a circuit constituting the power supply system, ringing or oscillation of the power supply voltage might occur. Such a variation of the power supply voltage causes a failure in startup of the power supply system or unstable operation of its peripheral devices.

It is therefore an object of the present disclosure to provide a semiconductor device that achieves stable rising of a power supply voltage with a dynamic control of the power supply voltage in a steady state.

An example semiconductor device that receives a power supply voltage output from a power supply device and having a value in accordance with an analog control signal, includes: a supply line configured to receive the power supply voltage; a resistance divider located between the supply line and ground and configured to divide the power supply voltage by using a resistor to obtain a divided voltage and to output the divided voltage as the analog control signal to the power supply device; and a control circuit configured to control a voltage division ratio in the resistance divider. The resistance divider includes one or more first resistors connecting the supply line to an output node of the analog control signal, one or more second resistors connecting the output node to the ground, one or more first switching devices connected to at least one of the one or more first resistors in parallel, and configured to be turned on or off in response to an output from the control circuit, and a second switching device connected to at least one of the one or more second resistors in parallel and configured to be turned on in response to a voltage equal to a voltage of the supply line. The control circuit turns on at least one of the one or more first switching devices in a period from when the power supply voltage rises to when the power supply voltage reaches a predetermined voltage. The control circuit starts controlling an on or off state of the one or more first switching devices after the power supply voltage has reached the predetermined voltage.

In this configuration, the resistance divider divides the voltage of the supply line in response to an output from the control circuit and feeds the divided voltage back to the power supply device. The fed-back power supply voltage having a value in accordance with the analog control signal is output to the supply line. The resistance divider includes first and second switching devices, and the resistance of the first path between the supply line and the output node of the analog control signal is variable by turning on or off the first switching device in response to an output from the control circuit. The second switching device is turned on in response to a voltage equal to the power supply voltage. The control circuit keeps the on state of the first switching device until the power supply voltage reaches the predetermined voltage. That is, the first and second switching devices are on until the power supply voltage reaches the predetermined voltage.

Suppose the second switching device is omitted and the first switching device is kept on until the power supply voltage reaches the predetermined voltage, for example. Then, since the ON resistance of the first switching device varies depending on the power supply voltage, the resistance of the first path changes. Thus, until the power supply voltage reaches the predetermined voltage, a transient change in the analog control signal occurs. Accordingly, the power supply voltage increases in a distorted manner as indicated by the solid line in FIG. 12, i.e., the increase of the power supply voltage is unstable. A similar phenomenon might also occur in a case where the first switching device is omitted and the second switching device is kept on.

On the other hand, in the present disclosure, both the first and second switching devices are kept on until the power supply voltage reaches the predetermined voltage, thereby cancelling a change of the analog control signal caused by a variation of ON resistance of one of the switching devices. That is, the power supply voltage can rise stably.

After the power supply voltage has reached the predetermined voltage, the resistance of the first path can be adjusted by turning on or off the first switching device. Thus, the analog control signal can be dynamically controlled, thereby enabling dynamic control of the power supply voltage in a steady state.

The semiconductor device may include a voltage detector configured to detect a voltage of the supply line. In this case, the control circuit controls an on or off state of the one or more first switching devices based on a result of detection by the voltage detector.

Each of the one or more first switching devices preferably has an ON resistance characteristic equal to an ON resistance characteristic of the second switching device.

Another example semiconductor device that receives a power supply voltage output from a power supply device and having a value in accordance with an analog control signal, includes: a supply line configured to receive the power supply voltage; a resistance divider located between the supply line and ground and configured to divide the power supply voltage by using a resistor to obtain a divided voltage and to output the divided voltage as the analog control signal to the power supply device; and a control circuit configured to control a voltage division ratio in the resistance divider. The resistance divider includes one or more first resistors connecting the supply line to an output node of the analog control signal, one or more second resistors connecting the output node to the ground, and one or more first switching devices connected to at least one of the one or more first resistors or at least one of the one or more second resistors, or connected to at least one of the one or more first resistors and at least one of the one or more second resistors, in parallel, and configured to be turned on or off in response to an output from the control circuit. The control circuit turns off all the one or more first switching devices in a period from when the power supply voltage rises to when the power supply voltage reaches a predetermined voltage. The control circuit starts controlling an on or off state of the one or more first switching devices after the power supply voltage has reached the predetermined voltage.

In this configuration, since all the first switching devices are off until the power supply voltage reaches the predetermined voltage, the resistance between the supply line and the output node and the resistance between the output node and the ground are constant. Thus, the analog control signal and the power supply voltage can rise stably. Then, the power supply voltage in a steady state can be dynamically controlled by turning on or off the first switching devices after the power supply voltage has reached the predetermined voltage.

The semiconductor device may include a voltage detector configured to detect a voltage of the supply line. In this case, the control circuit controls an on or off state of the one or more first switching devices based on a result of detection by the voltage detector.

### BRIEF DESCRIPTION OF THE DRAWINGS

FIG. 1 illustrates a configuration of a power supply system including a semiconductor device according to a first embodiment.

FIG. 2 is a graph showing changes in voltage and resistance in the semiconductor device of the first embodiment.

FIG. 3 is a graph showing an ON resistance characteristic of a PMOS transistor.

FIG. 4 is a graph showing ON resistance characteristics of a PMOS transistor and an NMOS transistor in FIG. 1.

FIG. 5 illustrates a variation of a resistance divider and an example configuration of a control circuit illustrated in FIG. 1.

FIG. 6 illustrates a configuration of a power supply system including a semiconductor device according to a second embodiment.

FIG. 7 a graph showing changes in voltage in the semiconductor device of the second embodiment.

FIG. 8 illustrates a configuration of a variation of a resistance divider illustrated in FIG. 6.

FIG. 9 illustrates a configuration of a variation of the semiconductor device illustrated in FIG. 6.

FIG. 10 illustrates a configuration of another variation of the semiconductor device illustrated in FIG. 6.

FIG. 11 illustrates a configuration of a conventional power supply system.

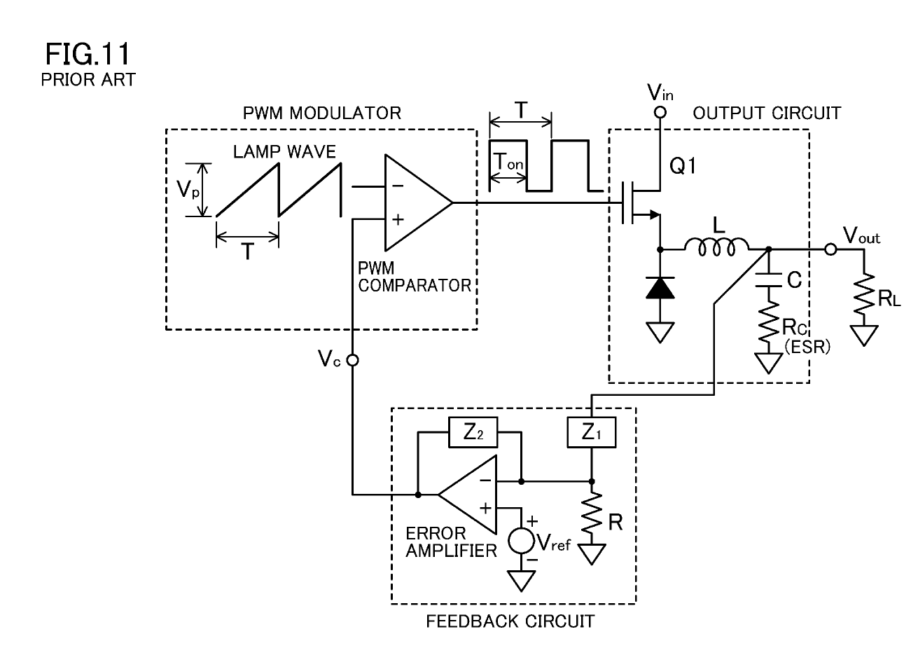

FIG. 12 is a graph showing a relationship between a rising time of a power supply voltage and a change of a power supply voltage.

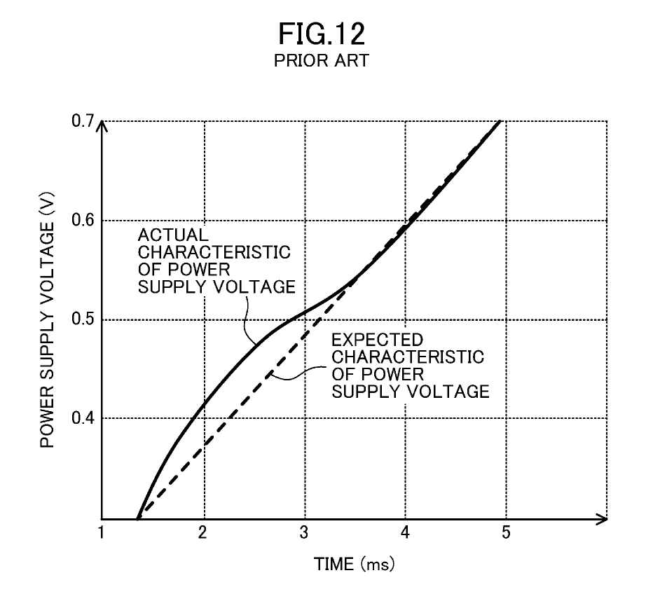

### DETAILED DESCRIPTION

### First Embodiment

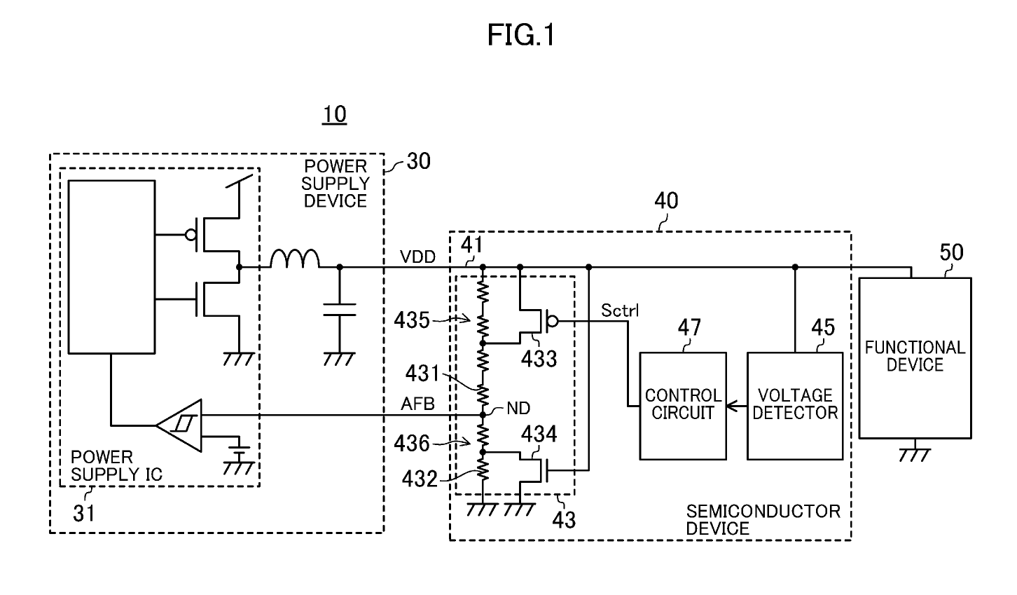

FIG. 1 illustrates a configuration of a power supply system including a semiconductor device according to a first embodiment. A power supply system 10 includes a power supply device 30, a semiconductor device 40, and a functional device 50.

The power supply device 30 includes a power supply integrated circuit (IC) 31 that receives an analog control signal AFB, which is a feedback voltage from the semiconductor device 40, and generates a power supply voltage VDD having a value in accordance with the analog control signal AFB. The power supply IC 31 only needs to generate a voltage in response to an analog signal, and may be a switching regulator or a linear regulator, for example. The power supply voltage VDD is supplied to the semiconductor device 40 and the functional device 50. The functional device 50 is a large scale integration (LSI) device or a liquid crystal panel, for example, and only needs to operate in response to the power supply voltage VDD.

The semiconductor device 40 includes a supply line 41 through which the power supply voltage VDD is supplied, a resistance divider 43, a voltage detector 45, and a control circuit 47.

The resistance divider 43 is located between the supply line 41 and the ground, and divides the voltage of the supply line 41. The divided voltage is output, as an analog control signal AFB, to the power supply device 30 through an output node ND.

The resistance divider 43 includes, for example, four resistors 431 serving as first resistors, two resistors 432 serving as second resistors, a PMOS transistor 433 serving as a first switching device, and an NMOS transistor 434 serving as a second switching device.

The resistors 431 are serially connected to one another, and is located on a first path 435 connecting the supply line 41 to the output node ND. The resistors 431 may be connected in parallel or in a ladder network. That is, the resistors 431 only need to connect the supply line 41 and the output node ND to each other. Thus, only one resistor 431 may be provided on the first path 435.

The resistors 432 are serially connected to one another, and are provided on a second path 436 connecting the output node ND to the ground. The resistors 432 may be connected to in parallel or in a ladder network. That is, the resistors 432 only need to connect the output node ND to the ground. Thus, only one resistor 432 may be provided on the second path 436.

The PMOS transistor 433 has its source connected to the supply line 41 and its drain connected to a point between the second and third resistors 431 when counted from the supply line 41. The gate of the PMOS transistor 433 is supplied with a control signal Sctr1 output from the control circuit 47. The PMOS transistor 433 only needs to be connected to at least one of the resistors 431 in parallel.

The NMOS transistor 434 has its source connected to the ground and its drain connected to a point between the first and second resistors 432 when counted from the ground. The gate of the NMOS transistor 434 is connected to the supply line 41. In this manner, the NMOS transistor 434 turns on when the power supply voltage VDD supplied to the supply line 41 exceeds the ground level. The NMOS transistor 434 may be connected to a plurality of resistors 432 in parallel. Another circuit may be connected to a point between the supply line 41 and the gate of the NMOS transistor 434. It is sufficient to supply a voltage equal to that of the supply line 41 to the gate of the NMOS transistor 434.

In this manner, the voltage division ratio of the resistance divider 43 is made variable by adjusting the resistance of the first path 435 constituted by the resistors 431 and the PMOS transistor 433 and the resistance of the second path 436 constituted by the resistors 432 and the NMOS transistor 434.

The voltage detector 45 detects the voltage of the supply line 41. The control circuit 47 outputs a control signal Sctr1 of an L level or an H level based on a result detected by the voltage detector 45, and turns the PMOS transistor 433 on or off. The voltage detector 45 does not need to operate in a period from when the power supply system 10 starts to when the power supply voltage VDD reaches a predetermined voltage.

The control circuit 47 keeps the PMOS transistor 433 on in a period from when the power supply voltage VDD starts to when the power supply voltage VDD reaches a predetermined voltage that is, for example, a voltage necessary for operation of the functional device 50. That is, a control signal Sctr1 of an L level. In a steady state in which the power supply voltage VDD is the predetermined voltage, a control signal Sctr1 of an L level or an H level is output, and the resistance ratio between the first and second paths 435 and 436 is controlled such that the steady state is maintained. In the steady state, the power supply voltage VDD is about 1.2 V and the analog control signal AFB is about 0.7 V, for example.

Specifically, when the power supply voltage VDD decreases from the predetermined voltage due to, for example, high-load conditions of the functional device 50, the control circuit 47 outputs a control signal Sctr1 of the H level and turns the PMOS transistor 433 off. Accordingly, the resistance of the first path 435 increases and the voltage value of the analog control signal AFB decreases, and thus, the power supply voltage VDD from the power supply device 30 returns to the predetermined voltage. The control circuit 47 determines whether or not the power supply voltage VDD reaches the predetermined voltage, based on a reset signal Rst, which will be described later.

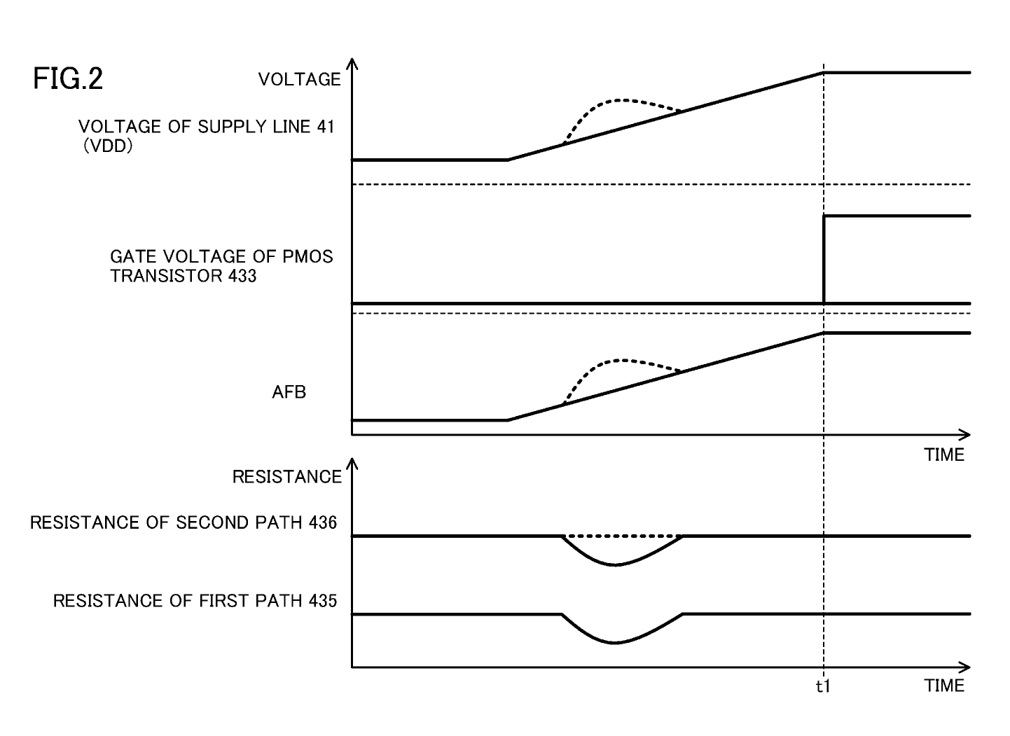

Control of the power supply voltage VDD by the semiconductor device 40 according to this embodiment will now be described with reference to FIG. 2. In FIG. 2, solid lines indicate changes in voltage and resistance in this embodiment.

When the power supply system 10 starts operating, the power supply voltage VDD output from the power supply device 30, i.e., the voltage value of the supply line 41, increases. Accordingly, the voltage value of the analog control signal AFB gradually increases.

In a period from when the power supply voltage VDD rises to time t1 when the power supply voltage VDD reaches the predetermined voltage, the gate voltage of the PMOS transistor 433 is at the L level, and thus, the PMOS transistor 433 is on. An increase in the voltage of the supply line 41 keeps the NMOS transistor 434 on. In general, transistors have ON resistances, which vary with changes in drain-to-source voltages.

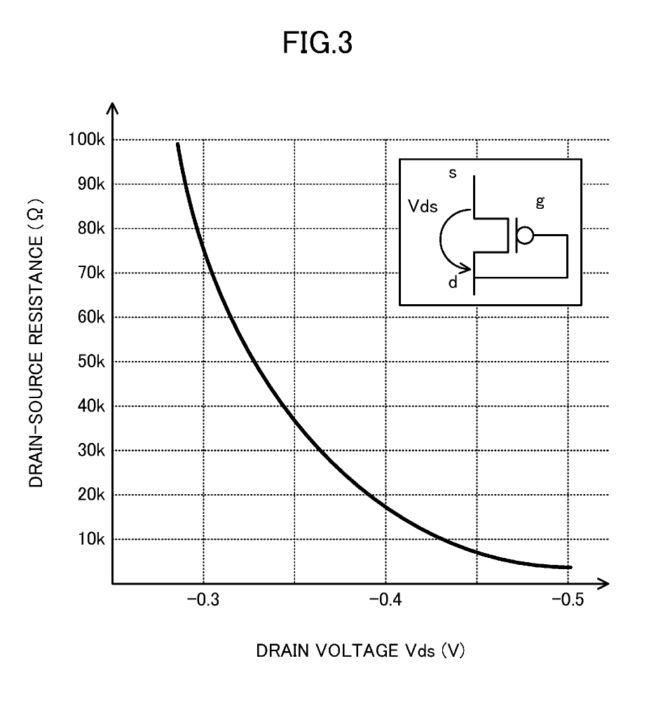

FIG. 3 is a graph showing an ON resistance characteristic of the PMOS transistor. As illustrated in FIG. 3, the ON resistance of the PMOS transistor varies depending on the drain voltage Vds. Thus, as illustrated in FIG. 2, the resistance of the first path 435 changes such that the graph of the resistance is distorted with a rise of the power supply voltage VDD.

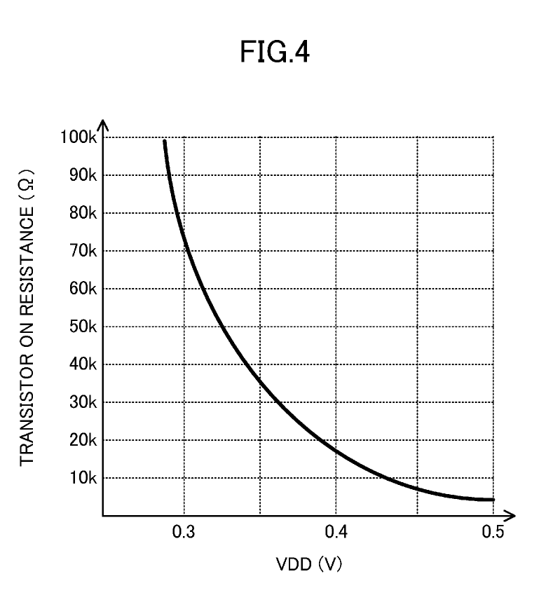

In this embodiment, it is assumed that the PMOS transistor 433 and the NMOS transistor 434 have ON resistance characteristics as illustrated in FIG. 4. That is, the ON resistance of the PMOS transistor 433 and the ON resistance of the NMOS transistor 434 with respect to the same power supply voltage VDD are the same. For example, the gate width of the NMOS transistor 434 is about a half of the gate width of the PMOS transistor 433.

Thus, as illustrated in FIG. 2, the resistance of the second path 436 changes similarly to the change in the resistance of the first path 435. The resistances of the first and second paths 435 and 436 also change similarly, thus stabilizing the analog control signal AFB. Accordingly, the power supply voltage VDD rises stably.

For example, in a case where the NMOS transistor 434 is omitted in the configuration of FIG. 1 as a configuration for controlling the voltage division ratio of the resistance divider 43, the resistance of the second path 436 shown in FIG. 2 does not change, and is expressed as a waveform indicated by a broken line. In this case, the waveform of the analog control signal AFB in FIG. 2 is distorted as indicated by the broken line, and thus, the power supply voltage VDD is expressed as a waveform indicated by the broken line. That is, the power supply voltage VDD becomes unstable. This situation might cause a failure in starting up the power supply system 10 or a malfunction of, for example, the functional device 50.

On the other hand, as described above, in this embodiment, in a rising period (i.e., a period from a start time of rising of VDD to time t1 in FIG. 2) from when the power supply voltage VDD starts rising to when the power supply voltage VDD reaches the predetermined voltage, the PMOS transistor 433 and the NMOS transistor 434 are turned on. Thus, distortion of waveform of the analog control signal AFB due to a change in resistance of the first path 435 is canceled by a change in resistance of the second path 436. As a result, the power supply voltage VDD stably rises as indicated by the solid line in FIG. 2.

After time t1, the power supply voltage VDD is in the steady state, and the gate voltage of the PMOS transistor 433 is controlled to be an L level or an H level in accordance with the voltage of the supply line 41. Accordingly, the resistance of the first path 435 can be controlled, thereby dynamically adjusting the power supply voltage VDD.

As described above, in this embodiment, since both the PMOS transistor 433 and the NMOS transistor 434 are turned on in the rising period of the power supply voltage VDD, distortion of waveform of the feedback voltage due to a change in ON resistance of the PMOS transistor 433 can be corrected by a change in ON resistance of the PMOS transistor 434. As a result, rising of the power supply voltage VDD can be stabilized. In addition, the power supply voltage VDD can be dynamically controlled in the steady state, and thus, responsiveness in power supply control is increased, resulting in enhanced operating characteristics of the functional device 50.

—Variation—

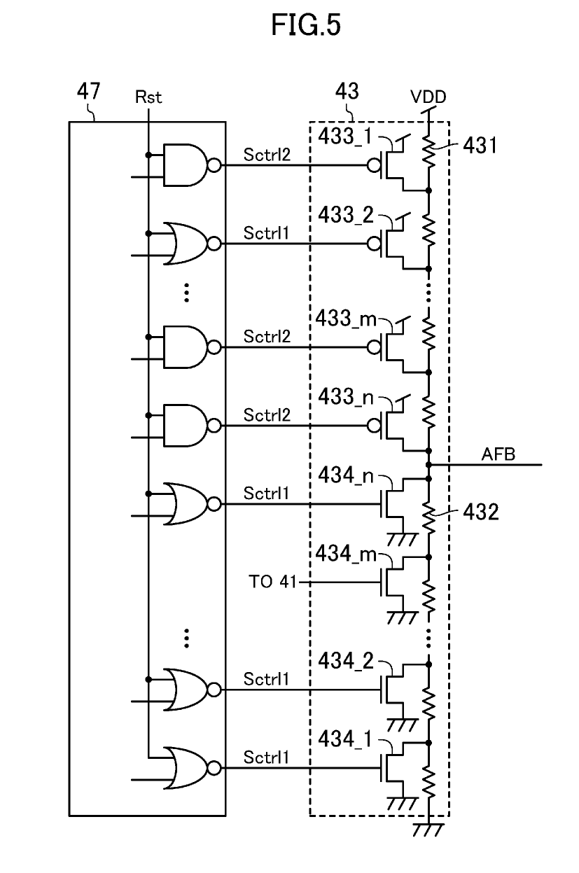

FIG. 5 illustrates a variation of the resistance divider of the first embodiment and an example configuration of a control circuit. In FIGS. 1 and 5, like reference characters have been used to designate identical or equivalent elements.

As illustrated in FIG. 5, the resistance divider 43 may include a plurality of PMOS transistors 433_1 to 433_{—}n and a plurality of NMOS transistors 434_1 to 434_{—}n. A control signal Sctr11 is supplied to the gate of the PMOS transistor 433_2 as a first switching device, and a control signal Sctr12 is supplied to the gates of the PMOS transistors 433_1, 433_{—}m, and 433_{—}n as third switching devices. A voltage equal to the voltage of the supply line 41 is supplied to the gate of the NMOS transistor 434_{—}m as a second switching device. A control signal Sctr11 is supplied to the gates of the NMOS transistors 434_1, 434_2, and 434_{—}n as fourth switching devices.

The control circuit 47 includes logic circuits including a plurality of NANDs and a plurality of NORs. The logic circuit receives a reset signal Rst and an internal signal. That is, each of the control signals Sctr11 and Sctr12 is a resulting signal of logic synthesis of the internal signal and the reset signal Rst. In the rising period of the power supply voltage VDD, the reset signal Rst is inactive (e.g., at an L level), and the internal signal is at an H level.

In the configuration of the control circuit 47 as illustrated in FIG. 5, in the rising period of the power supply voltage VDD, the PMOS transistor 433_2 turns on but the PMOS transistors 433_1, 433_{—}m, and 433_{—}n turn off. In this period, the NMOS transistor 434_{—}m turns on but the NMOS transistors 434_1, 434_2, and 434_{—}n turn off in response to the control signal Sctr11.

When the power supply voltage VDD rises, the logic circuit receives a reset signal Rst that is active (i.e., at an H level), and thus, enables power supply control in accordance with the logical level of the internal signal. For example, the internal signal may be generated based on a detection result of the voltage detector 45 (see, for example, FIG. 1).

As described above, the use of a plurality of transistors enables a fine adjustment of the resistance of the first path 435, thereby enabling power supply control with high resolution in the steady state.

In the semiconductor device of this embodiment, one PMOS transistor 433 may be connected to one resistor 431 in parallel and one NMOS transistor 434 may be connected to one resistor 432 in parallel. A plurality of transistors on the first and second paths 435 and 436 may be individually controlled by the control circuit 47.

The number of PMOS transistors 433 may differ from the number of the NMOS transistors 434. For example, to turn two PMOS transistors 433 on in the rising period of the power supply voltage VDD, one NMOS transistor 434 having an ON resistance corresponding to ON resistances of these PMOS transistors 433 may be provided to turn the NMOS transistor 434 on.

With this configuration, even in a case where two PMOS transistors 433 are inserted in the first path 435, only one NMOS transistor 434 is necessary in the second path 436, and thus, an increase in circuit scale of the semiconductor device 40 can be reduced.

In the semiconductor device illustrated in FIG. 1, control as described above may be performed by supplying the control signal Sctr1 to the gate of the NMOS transistor 434.

### Second Embodiment

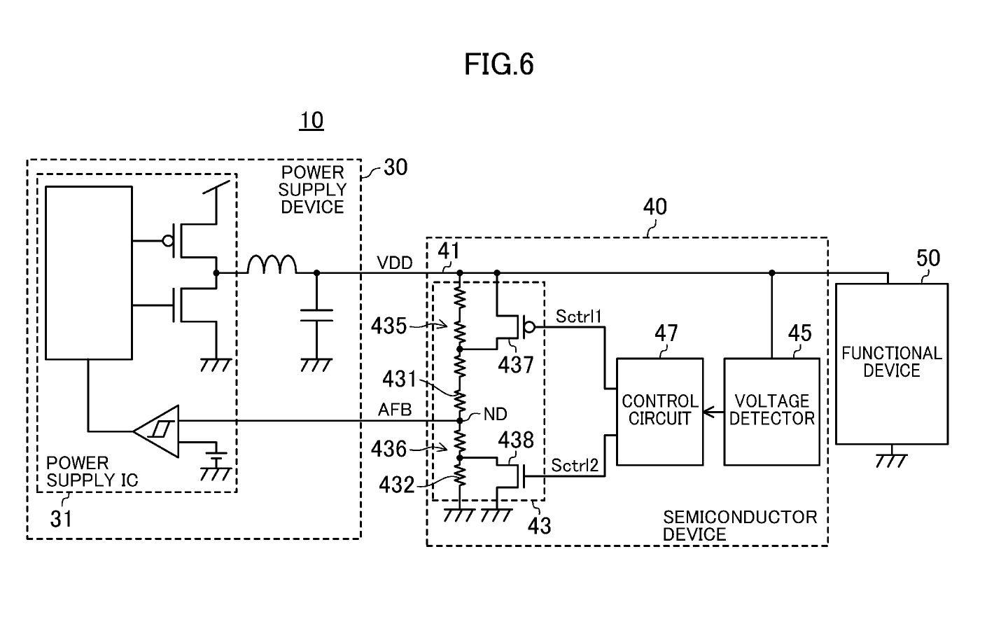

FIG. 6 illustrates a configuration of a power supply system including a semiconductor device according to a second embodiment. In FIGS. 1 and 6, like reference characters have been used to designate identical or equivalent elements. In this embodiment, a control signal Sctr11 is supplied to the gate of a PMOS transistor 437 as a second switching device, and a control signal Sctr12 is supplied to the gate of an NMOS transistor 438 as a third switching device.

A control circuit 47 supplies an H-level control signal Sctr11 to the gate of the PMOS transistor 437 and an L-level control signal Sctr12 to the gate of the NMOS transistor 438 until a power supply voltage VDD rises to a predetermined voltage. Then, when the power supply voltage VDD reaches the predetermined voltage, the control circuit 47 outputs H- or L-level control signals Sctr11 and Sctr12 in accordance with a detection result of a voltage detector 45.

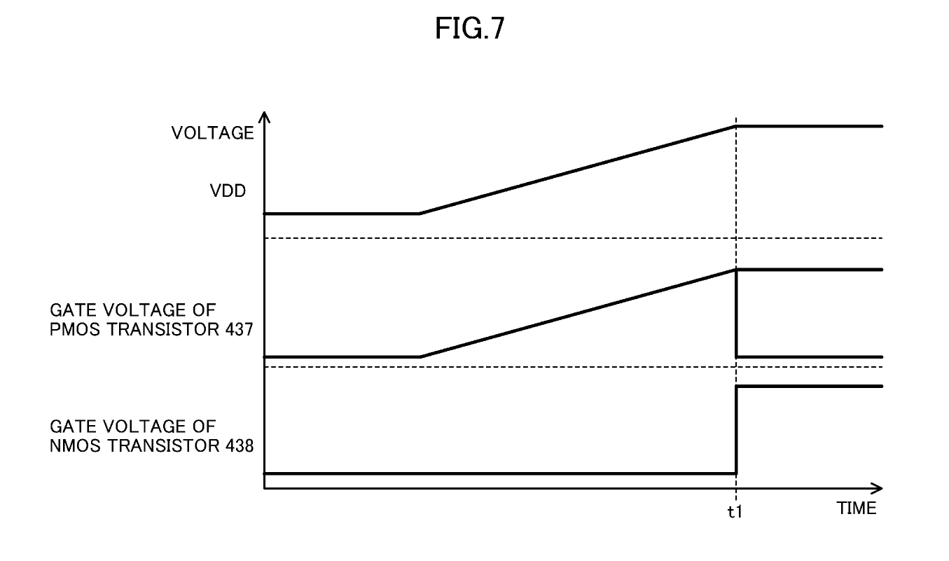

Specifically, as illustrated in FIG. 7, in a period from when the power supply voltage VDD rises to time t1 when the power supply voltage VDD reaches the predetermined voltage, the gate voltage of the PMOS transistor 437 is at the H level, and thus, the PMOS transistor 437 is off. In addition, the gate voltage of the NMOS transistor 438 is at the L level, and thus, the NMOS transistor 438 is off.

After time t1, the gate voltage of the PMOS transistor 437 is controlled to the L level or the H level in accordance with a detection result of the voltage detector 45. The gate voltage of the NMOS transistor 438 changes to the H level.

As described above, in this embodiment, in the rising period of the power supply voltage VDD, the PMOS transistor 437 and the NMOS transistor 438 are individually off, and thus, the influence of ON resistances of these transistors can be disregarded. Specifically, in the rising period of the power supply voltage VDD, the resistances of first and second paths 435 and 436 are constant, and thus, stably increase without distortion of waveforms of an analog control signal AFB and the power supply voltage VDD.

After the power supply voltage VDD has reached the predetermined voltage, the resistance of the first path 435 can be adjusted by turning the PMOS transistor 437 on or off. In this manner, the power supply voltage VDD can be dynamically controlled.

The resistance of the second path 436 may be adjusted by turning the NMOS transistor 438 on or off after the power supply voltage VDD has reached the predetermined voltage.

A plurality of PMOS transistors 437 and a plurality of NMOS transistor 438 may be provided, and the number of the PMOS transistors 437 and the number of the NMOS transistors 438 are not specifically limited.

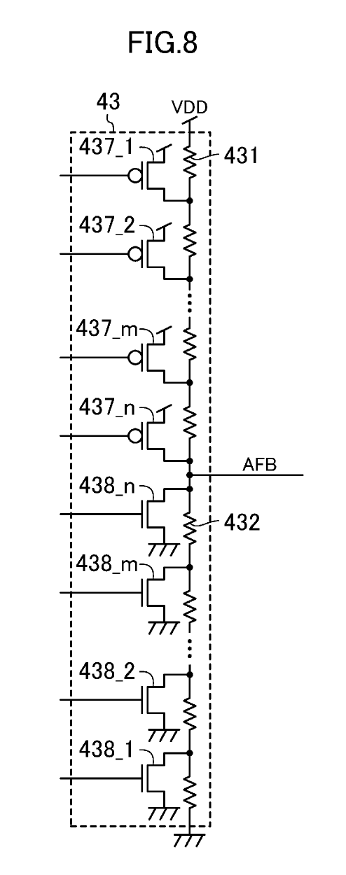

FIG. 8 illustrates an example configuration in which a plurality of PMOS transistors 437 and a plurality of NMOS transistors 438 are provided.

In the configuration of a resistance divider 43 illustrated in FIG. 8, in the rising period of the power supply voltage VDD, all the PMOS transistors 437_1 to 437_{—}n and all the NMOS transistors 438_1 to 438_{—}n are turned off. In this configuration, after the power supply voltage VDD has reached the predetermined voltage, at least one of the PMOS transistors 437_1 to 437_{—}n and NMOS transistors 438_1 to 438_{—}n is turned on or off.

The use of a plurality of transistors enables a fine adjustment of resistances of the first and second paths 435 and 436, and thus, power supply control with high resolution can be achieved.

In the semiconductor device 40 illustrated in FIG. 6, either the PMOS transistors 437 or the NMOS transistors 438 may be omitted.

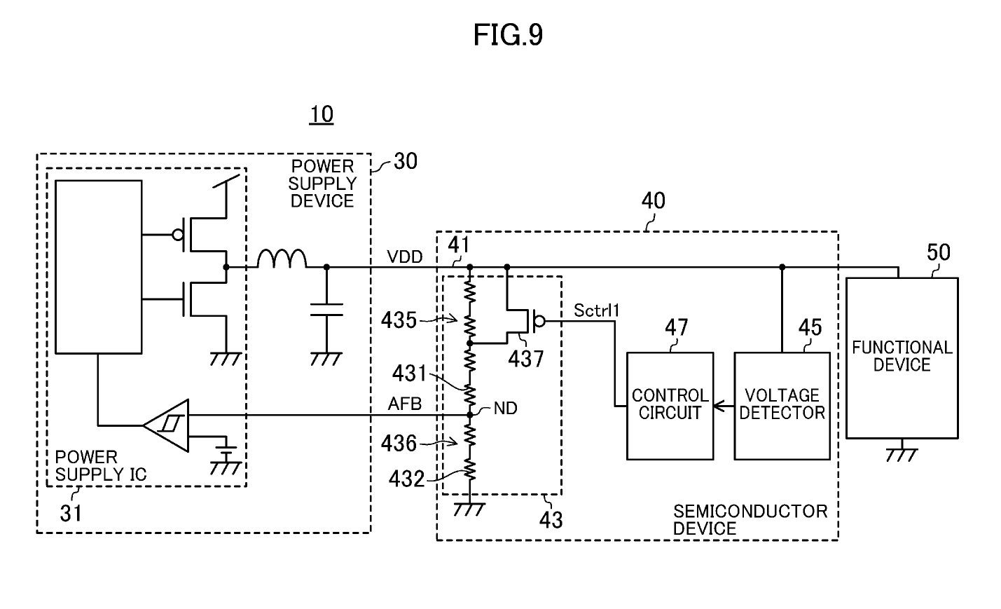

Specifically, FIG. 9 illustrates a configuration in which the NMOS transistor 438 is removed from the semiconductor device 40 illustrated in FIG. 6. In the semiconductor device 40 of FIG. 9, in the rising period of the power supply voltage VDD, the PMOS transistor 437 as a first switching device is turned off.

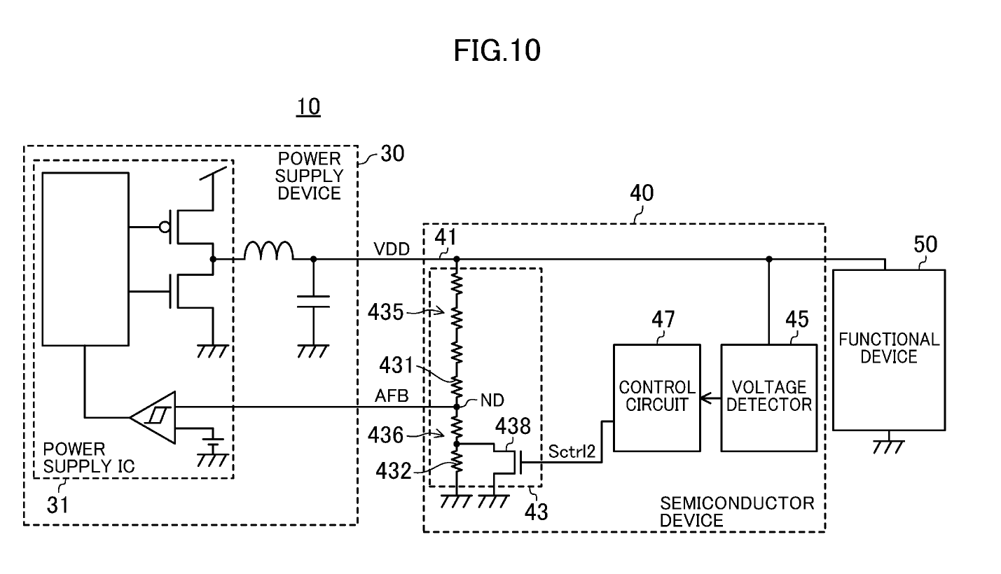

FIG. 10 illustrates a configuration in which the PMOS transistor 437 is removed from the semiconductor device 40 illustrated in FIG. 6. In the semiconductor device 40 of FIG. 10, in the rising period of the power supply voltage VDD, the NMOS transistor 438 as a first switching device is turned off.

As described above, in the semiconductor devices 40 illustrated in FIGS. 9 and 10, a small number of transistors are to be controlled, and thus, the circuit areas of the semiconductor devices 40 can be reduced.

The foregoing embodiments are directed to the case where the power supply voltage VDD rises. Alternatively, the above-described control may be performed when the power supply voltage VDD falls.

What is claimed is:

1. A semiconductor device that receives a power supply voltage from a power supply device, the power supply voltage having a value in accordance with an analog control signal, the semiconductor device comprising:
a supply line configured to receive the power supply voltage;
a resistance divider located between the supply line and ground and configured to divide the power supply voltage by using a resistor to obtain a divided voltage and to output the divided voltage as the analog control signal to the power supply device; and
a control circuit configured to control a voltage division ratio in the resistance divider, wherein
the resistance divider includes
one or more first resistors connecting the supply line to an output node of the analog control signal,
one or more second resistors connecting the output node to the ground,
one or more first switching devices connected to at least one of the one or more first resistors in parallel, and configured to be turned on or off in response to an output from the control circuit, and
a second switching device connected to at least one of the one or more second resistors in parallel and configured to be turned on in response to a voltage equal to a voltage of the supply line,
the control circuit turns on at least one of the one or more first switching devices in a period from when the power supply voltage rises to when the power supply voltage reaches a predetermined voltage, and
the control circuit starts controlling an on or off state of the one or more first switching devices after the power supply voltage has reached the predetermined voltage.

2. The semiconductor device of claim 1, wherein
the resistance divider includes
a third switching device connected to at least one of the one or more first resistors in parallel, and configured to be turned on or off in response to an output from the control circuit, and
a fourth switching device connected to at least one of the one or more second resistors in parallel, and configured to be turned on or off in response to an output from the control circuit,
the control circuit turns off the third and fourth switching devices in the period from when the power supply voltage rises to when the power supply voltage reaches the predetermined voltage, and
the control circuit starts controlling an on or off state of the third switching device after the power supply voltage has reached the predetermined voltage.

3. The semiconductor device of claim 1, further comprising
a voltage detector configured to detect a voltage of the supply line, wherein
the control circuit controls an on or off state of the one or more first switching devices based on a result of detection by the voltage detector.

4. The semiconductor device of claim 1, wherein
the control circuit receives a reset signal that is inactive in the period from when the power supply voltage rises to when the power supply voltage reaches the predetermined voltage and is active when the power supply voltage reaches the predetermined voltage, and
the control circuit turns on the one or more first switching devices when the reset signal is inactive.

5. The semiconductor device of claim 1, wherein
each of the one or more first switching devices has an ON resistance characteristic equal to an ON resistance characteristic of the second switching device.

6. The semiconductor device of claim 1, wherein
the second switching device is an NMOS transistor having a gate connected to the supply line.

7. A semiconductor device that receives a power supply voltage from a power supply device, the power supply voltage having a value in accordance with an analog control signal, the semiconductor device comprising:
a supply line configured to receive the power supply voltage;
a resistance divider located between the supply line and ground and configured to divide the power supply voltage by using a resistor to obtain a divided voltage and to output the divided voltage as the analog control signal to the power supply device; and
a control circuit configured to control a voltage division ratio in the resistance divider, wherein
the resistance divider includes
one or more first resistors connecting the supply line to an output node of the analog control signal,
one or more second resistors connecting the output node to the ground, and
one or more first switching devices connected to at least one of the one or more first resistors or at least one of the one or more second resistors, or connected to at least one of the one or more first resistors and at least one of the one or more second resistors, in parallel, and configured to be turned on or off in response to an output from the control circuit,
the control circuit turns off all the one or more first switching devices in a period from when the power supply voltage rises to when the power supply voltage reaches a predetermined voltage, and
the control circuit starts controlling an on or off state of the one or more first switching devices after the power supply voltage has reached the predetermined voltage.

8. The semiconductor device of claim 7, wherein
the resistance divider includes
a second switching device connected to at least one of the one or more first resistors in parallel, and configured to be turned on or off in response to an output from the control circuit, and
a third switching device connected to at least one of the one or more second resistors in parallel, and configured to be turned on or off in response to an output from the control circuit,
the control circuit turns off the second and third switching devices in the period from when the power supply voltage rises to when the power supply voltage reaches the predetermined voltage, and
the control circuit starts controlling an on or off state of at least one of the one or more second switching devices or the third switching device after the power supply voltage has reached the predetermined voltage.

9. The semiconductor device of claim 7, further comprising
a voltage detector configured to detect a voltage of the supply line, wherein
the control circuit controls an on or off state of the one or more first switching devices based on a result of detection by the voltage detector.

10. The semiconductor device of claim 7, wherein
the control circuit receives a reset signal that is inactive in the period from when the power supply voltage rises to when the power supply voltage reaches the predetermined voltage and is active when the power supply voltage reaches the predetermined voltage, and
the control circuit turns off the one or more first switching devices when the reset signal is inactive.

11. A power supply system comprising:
the semiconductor device of claim 1; and
the power supply device.

12. A power supply system comprising:
the semiconductor device of claim 7; and
the power supply device.
